(19) United States
(12) Patent Application Publication
(10) Pub. No.: US 2026/0025051 A1
(43) Pub. Date: Jan. 22, 2026

(54) Continuous Rotating Machine To Move A Power Generator Or Create Rotational Motion

(71) Applicant: Nathan Kress, Sarasota, FL (US)

(72) Inventor: Nathan Kress, Sarasota, FL (US)

(21) Appl. No.: 19/271,994

(22) Filed: Jul. 17, 2025

Related U.S. Application Data
(60) Provisional application No. 63/673,455, filed on Jul. 19, 2024.

(51) Int. Cl. H02K 41/02; F03G 7/10; H02K 7/102

(52) U.S. Cl. CPC H02K 41/02; F03G 7/10; H02K 7/102

(57) ABSTRACT

A mechanical motion system is disclosed that generates continuous or semi-continuous rotational or linear motion. In the rotational design, rigid or jointed arms extend from a central hub at an angle toward a circular track, creating torque through slipping and compression. The linear design uses an angled magnet on a platform moving along a repelling magnetic track to produce propulsion. Both systems employ low-friction elements, tension mechanisms, and optionally telescoping arms or modular tracks. Mechanical or electrical energy is harvested through direct drive or gear-coupled generators. Configurations can include gravity-assisted or mechanical adjustment, environmental sealing, and sensor feedback. Auxiliary starters and brakes control operation. This invention offers a scalable, low-maintenance alternative to electric motors for off-grid, industrial, and clean energy use, enabling efficient mechanical energy conversion with minimal reliance on electronics.

### CROSS-REFERENCE TO RELATED APPLICATIONS

This application claims the benefit of U.S. Provisional Application No. 63/673,455, filed on Jul. 18, 2024, entitled “Continuous Rotating Machine To Move A Power Generator Or Create Rotational Motion.” The entire disclosure of the referenced application is hereby incorporated by reference.

### FIELD OF INVENTION

The present invention relates generally to mechanical motion generation systems and devices. More specifically, it pertains to systems that generate continuous or semi-continuous mechanical motion—either rotational or linear—using fixed or angularly adjustable arms engaged with a circular track, or using angled magnetic platforms propelled along a linear or curvilinear track by repelling magnetic forces.

The invention is particularly directed toward mechanical systems that transform this motion into useful mechanical work or electrical energy through guided slipping, torque-enhancing compression, and magnetic force vector decomposition. Applications include energy generation, non-electric mechanical drive systems, modular motion assemblies, autonomous propulsion mechanisms, and replacements for conventional electric motors in sensitive or off-grid environments.

### BACKGROUND

Mechanical energy generation systems have historically relied on rotating components such as turbines, engines, and electric motors to provide continuous or semi-continuous motion for mechanical work or power generation. Traditional systems are often composed of complex assemblies with numerous moving parts requiring substantial energy inputs, ongoing maintenance, lubrication, and dependence on electronic components. Electric motors, while dominant in modern applications, require consistent electrical input, are prone to electronic failure, and experience inefficiencies such as resistive heating and mechanical losses.

Conventional rotational systems using gears, shafts, and drive trains also face issues of frictional wear, bearing degradation, the need for tight manufacturing tolerances, and operational limitations under prolonged or fluctuating loads. Renewable mechanical systems, such as wind turbines and water wheels, offer sustainability but depend on variable environmental conditions that limit reliability and consistent output.

Efforts to reduce mechanical and electrical complexity have included passive motion systems, oscillatory mechanisms, and electromagnetic drive platforms. However, many of these alternatives lack the torque, stability, or scalability needed for widespread industrial or commercial deployment. Systems relying on passive slipping or simplified propulsion methods often suffer from insufficient control or mechanical efficiency to compete with established energy technologies.

Accordingly, there remains a need for mechanical motion systems capable of producing continuous or semi-continuous motion-either rotational or linear-without the drawbacks of traditional motors. An ideal system would minimize reliance on electronic components, reduce friction, offer modular scalability, and maintain mechanical stability under load. It should provide a viable replacement or enhancement to electric motors and traditional drive systems while functioning in a range of environmental conditions and use cases.

The present invention addresses these challenges by offering a novel mechanical energy platform that utilizes either angularly offset arms on a circular track or angled magnets on a linear track. The invention generates torque or linear propulsion through guided slipping, compression-enhanced contact, and magnetic repulsion vector decomposition. With low-friction interfaces, modular construction, and minimal startup energy requirements, the system provides an efficient, scalable, and resilient alternative to conventional motion and power generation technologies.

### SUMMARY OF THE INVENTION

The present invention relates to a mechanical motion generation system that produces continuous or semi-continuous rotational or linear motion using either angularly offset arms on a circular track or angled magnets propelled along a linear or curvilinear track. This system is designed to perform mechanical work or generate electrical energy, providing a non-traditional alternative to electric motors and conventional energy conversion systems. It operates through low-friction guidance, magnetic repulsion, compression-assisted slipping, and fixed or lockable angular configurations.

The core design includes a central rotating hub from which one or more rigid or semi-rigid arms extend outward at a deliberate offset angle. These arms are geometrically shaped or jointed to maintain a fixed oblique orientation relative to the circular track's tangent, producing continuous torque. Alternatively, a magnetic propulsion variant features a magnet mounted at an angle on a platform that travels along a repelling magnetic track, where vector decomposition produces both propulsion and stabilization.

The system supports vertical and horizontal layouts. Vertical systems use gravity-assisted arm extension, while horizontal systems rely on mechanical or actuator-based adjustment. Both configurations include tensioning mechanisms such as springs, weights, or magnetic positioning aids to enhance contact and force consistency. Arms may also be telescoping, groove-guided, and sensor-adjusted to maintain performance across varying load conditions.

The generated motion can drive mechanical devices or be converted into electricity via gear-coupled alternators or generators. The modular design allows for scalable stacking, tandem operation, or synchronized arrays of multiple arms or magnetic platforms. Auxiliary startup systems—including hand cranks, pneumatic boosters, or electromagnetic pulses—provide initial motion, while braking components ensure controlled deceleration.

The invention accommodates both inward- and outward-angled arms and leverages angular resistance and slipping to enhance torque. Its robust design suits industrial, off-grid, and environmentally sensitive contexts where traditional motors are unsuitable. The system offers durable, energy-efficient, and low-maintenance mechanical motion with wide applicability.

In summary, the invention introduces a novel motion generation platform that converts angular tension and magnetic repulsion into guided rotational or linear movement. Its adaptability, environmental resilience, and capacity to replace or supplement traditional motors mark a significant advancement in sustainable mechanical energy systems.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a side perspective view of a horizontal circular track embodiment, showing a vertically supported rotating hub with a single angled arm connected to a grooved wheel in contact with the circular track.

FIG. 2 is a schematic view of a linear magnetic propulsion system, illustrating a cart-mounted angled magnet positioned above a magnetically repulsive track configured for continuous or looped motion.

FIG. 3 is a side perspective view of a vertical circular track embodiment, showing two angularly connected arms pressing a sliding cart downward into the track groove to generate rotational torque.

FIG. 4 is a top view of a horizontal circular track configuration, showing a curved arm extending from a central hub to a groove-following cart, with adjustable tension provided via a rotating center tub.

FIG. 5 is a vertical circular track embodiment featuring a weight-loaded central hub, wherein the downward force from the weight dynamically alters the angle of a dual-arm assembly connected to a sliding cart for tension-based torque generation.

FIG. 6 is a vertical circular track embodiment similar to FIG. 5, but employing a compressed spring instead of a weight to push the rotating hub downward, thereby adjusting the arm angles and tension to generate motion in the connected sliding cart.

### DETAILED DESCRIPTION OF THE DRAWINGS

The accompanying drawings illustrate embodiments of the invention and, together with the detailed description, serve to explain the principles of the invention.

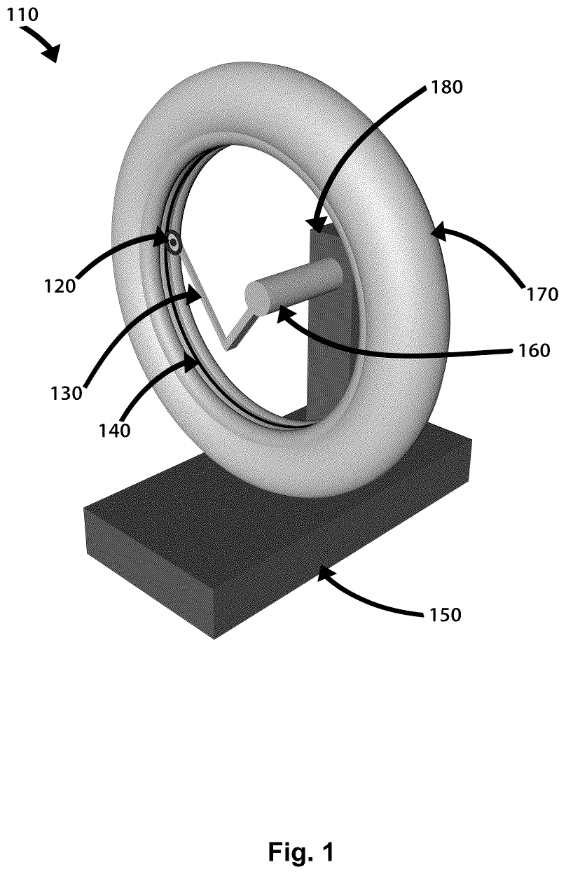

FIG. 1 illustrates a horizontal embodiment of the circular track motion system wherein the rotating mechanism is positioned vertically, supported upright by a structural base. In this configuration, a single wheel (120) acts as the motion interface, engaging with a grooved circular track (170) via a track-following groove (140) formed into the wheel. The wheel (120) is rigidly affixed to an angled arm (130), which extends outward from the central hub (160). This arm (130) features a forward-then-backward angular profile that produces a tangential force against the track. The circular track (170) is mounted independently on the base platform (150) alongside a vertical support arm (180). This vertical arm (180) anchors and stabilizes the central rotating hub (160), which is capable of locking the arm into a preset tension position to optimize engagement with the track. The entire assembly depicted is labeled as element 110.

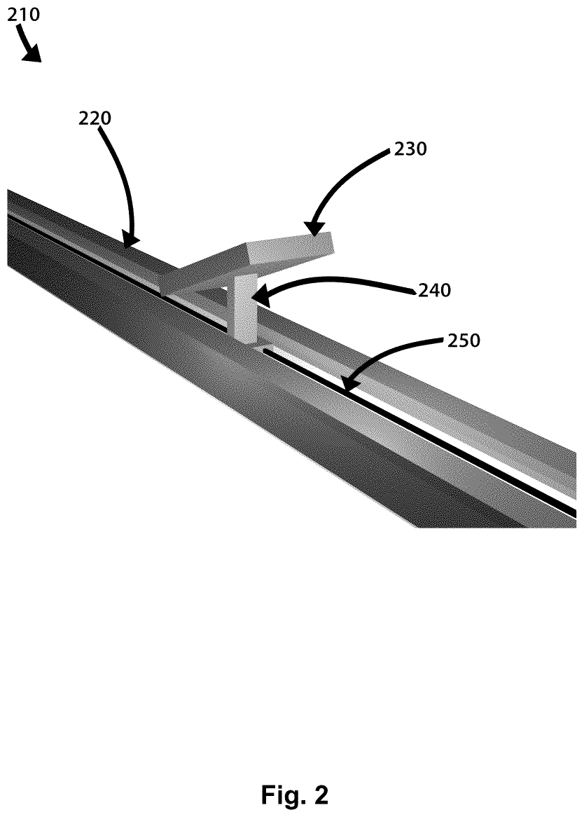

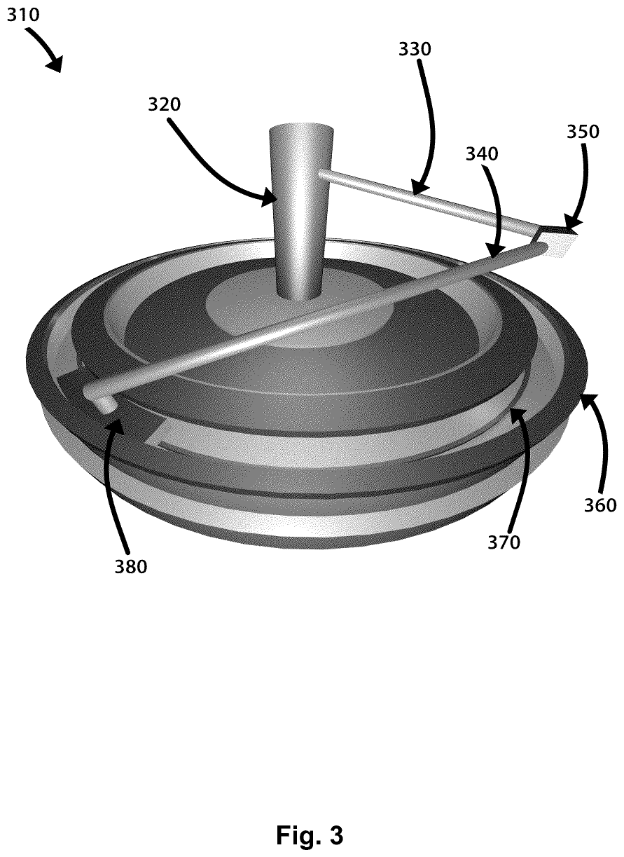

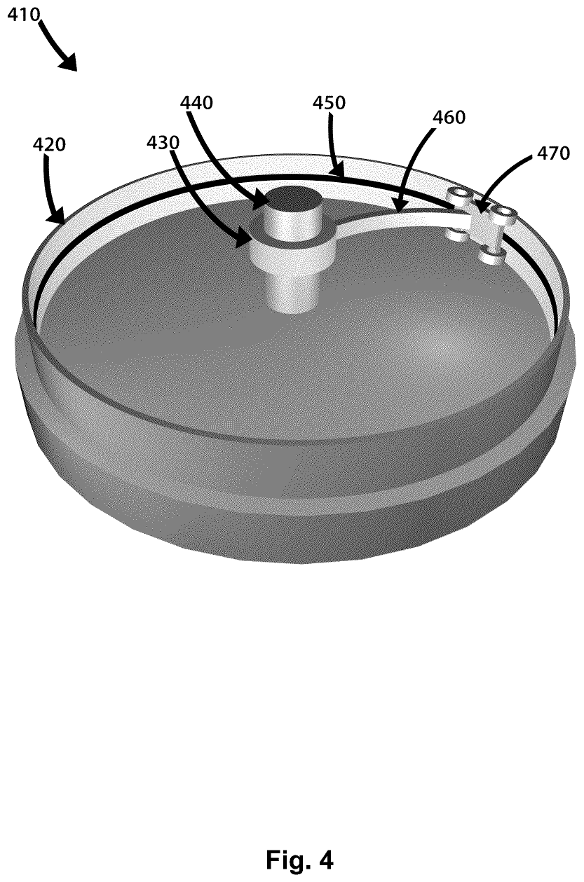

FIG. 2 presents an alternate embodiment that utilizes linear or curvilinear magnetic repulsion to induce motion. In this arrangement, a cart (230) supports a magnet or combination of magnets (230) mounted at an angle optimized to produce a decomposed repulsive force. The front portion of the magnet is tilted more vertically upward, while the rear is angled more downward, allowing for effective decomposition of the repulsive magnetic field. This assembly glides along a magnetic track (220), which may be shaped as a loop or remain straight. A track groove (250) centers the cart laterally, ensuring continuous guidance along the pathway. The angled magnet (230) is affixed to the cart via a vertical support column (240) that prevents collision between the magnet and the track. The configuration enables uninterrupted, frictionless motion by decomposing magnetic force into horizontal and vertical components. The full drawing is denoted by element 210. FIG. 3 shows a vertical embodiment of the circular track system where the torque arm assembly pushes downward and outward into the circular track (260) from a raised platform. A rotating central hub (320) is positioned at the middle of the circular system and vertically extends upward. Two arms—a first rearward-projecting arm (330) and a second forward-projecting arm (340)—are joined via flexible or lockable joints (250) to allow fine-tuned angular adjustment. These arms cooperate to press a cart (380) against the track groove (370) of the circular track (260). The structure allows increased mechanical compression as the arms are lowered, enhancing torque generation. The combined angled configuration of the arms and joints increases tension against the track, resulting in sustained rotational energy transfer. The full figure is identified by element 310. FIG. 4 depicts a horizontal platform-based embodiment of the circular track invention in which a cart (470) slides along the groove (450) of a circular track (420). A central hub (430) allows for radial adjustment of a single curving arm (460) that connects the cart to the center. The arm (460) has a smooth compound curve to produce tangential force against the track. The hub (430) is housed inside a rotating circular tub (440) that permits adjustment to increase or decrease arm tension via a lever or actuator. This enables precision control of arm-track engagement pressure. The entire layout shown is labeled as element 410.

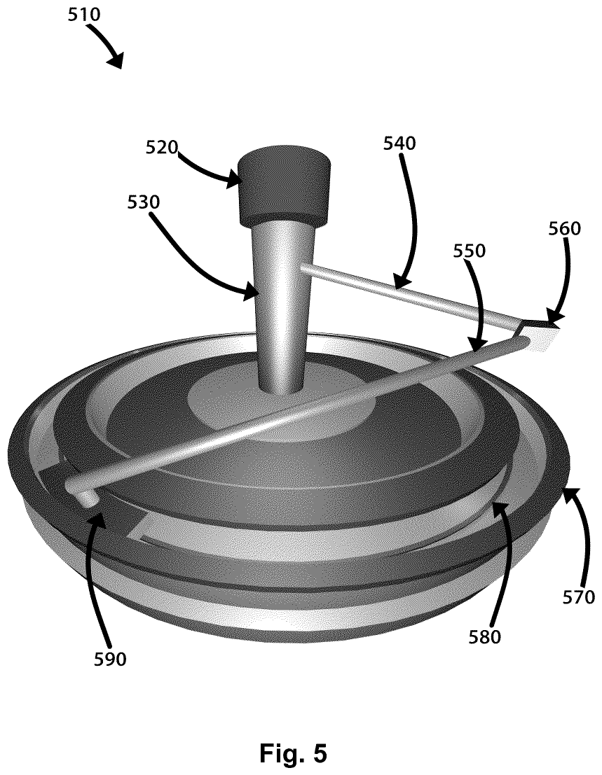

FIG. 5 illustrates a vertical version of the circular track embodiment incorporating a weighted tension mechanism. A central rotating hub (530) is vertically aligned and subject to downward force from a weight (520) positioned at the top. As the weight pushes the hub downward, a first arm (540) connected to the hub shifts its vertical angle relative to the circular track (570). This angular change adjusts the tension of a second arm (550), which is joined to the first arm at a flexible connection point (560) and extends to a cart (590). The cart (590) follows a groove (580) embedded in the circular track (570). This configuration allows dynamic adjustment of arm angles and engagement force based on the magnitude of the top weight, enhancing mechanical pressure and torque generation. The complete drawing is referenced as element 510.

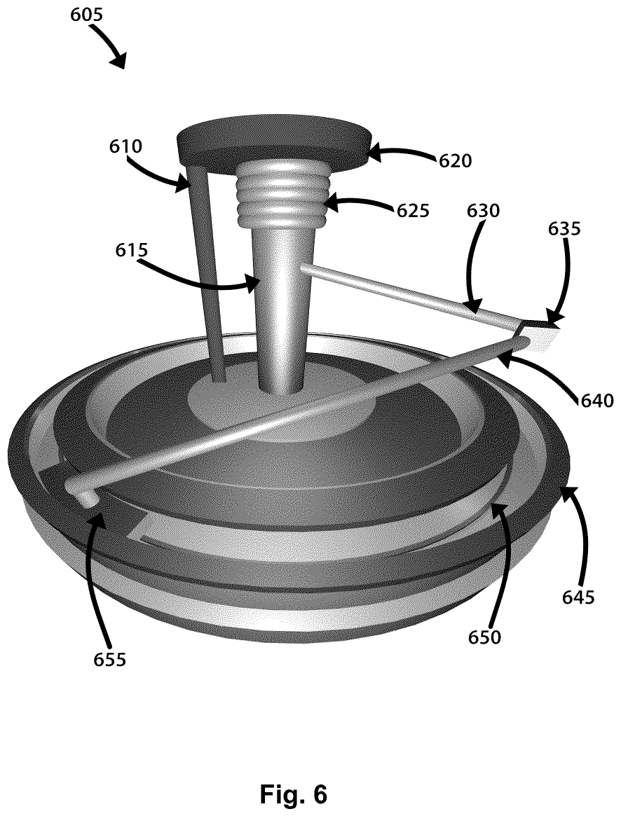

FIG. 6 shows a variation of the weighted tension configuration using a compressed spring instead of a static weight. The circular track (645) is vertically aligned and mounted on a supporting base. A spring-loaded support structure (610) holds a compressed spring (625) anchored at its lower base (620). The spring (625) exerts downward force on a rotating hub (615), which adjusts the angle of a first arm (630). This arm is connected to a second arm (640) at a joint (635), forming a rigid linkage system. The second arm (640) connects to a cart (655), which slides along a groove (650) in the circular track (645). This design enables spring-controlled engagement and pressure modulation between the arm and track, providing a tunable, self-regulating tension mechanism. The entire system is identified as element 605.

### DETAILED DESCRIPTION

The present invention provides a system for generating continuous or semi-continuous mechanical motion. This system operates either through a circular track with a rotating arm mechanism or via a linear magnetic propulsion arrangement. It is designed to replace or complement conventional electric motors and can be configured to perform mechanical work or to generate electrical energy by coupling with alternators or generators. The system is modular and scalable, suitable for integration in both compact portable devices and large-scale industrial platforms.

In the circular track mechanism, the invention includes two primary configurations: a vertical shifting embodiment and a horizontal (flat) embodiment. Both utilize a central hub and outward-extending arms that interact with a circular track to generate torque through guided slipping motion. These two orientations accommodate varying environmental and mechanical constraints while delivering the same fundamental tangential force generation.

In the circular track embodiment, a central hub or pivot point is precisely positioned at the geometric center of a fixed or semi-fixed circular track. Extending radially from this hub are one or more arms, each designed to interact with the track through a unique angled profile. Each arm consists of a single rigid or semi-rigid structure or a combination of rigid segments joined at fixed or adjustable joints. The geometry of the arm causes it to project outward not in a purely radial line, but initially in a forward or rearward direction before shifting angle to extend toward the track. This angular construction may be formed as a continuous rigid shape or assembled from components connected at a hinge or joint that allows the user or system to select and lock in a desired angle.

This multi-angled configuration ensures the arm contacts the circular track at an oblique angle relative to the track's local tangent. As a result, a tangential component of force is generated, enabling torque production about the central hub. The contact interface between the arm and the track may consist of low-friction sliding surfaces, rolling elements, or magnetic repulsion systems. In any of these forms, the interface allows reactive force to build and transmit motion around the circular path.

As the system operates, forces acting on the arm—whether from gravity, spring compression, or magnetic bias—shift the arm from a more vertical orientation into its fixed angled configuration. This shift causes an increase in the effective length of the arm along the curvature of the track. Since the track's radius remains constant, this elongation introduces mechanical compression, increasing the contact force between the arm and the track and enhancing torque transfer.

To facilitate this dynamic, the system may include components such as springs, weight-based loads, or magnetic positioning aids that help initiate and sustain the arm's angular contact. As the arm resists straightening against the curvature of the track, it creates a tightening action that reinforces its grip and multiplies torque output through mechanical resistance.

In the vertical shifting configuration, the arm is mounted to a vertically aligned hub and can be repositioned by sliding it downward. As the arm slides lower, it projects further outward due to its angled shape, thereby increasing its engagement with the track. Once the desired extension is reached, a mechanical locking system holds it in place. An optional electrically powered actuator can assist with positioning, allowing programmable control. Gravity aids this process by enhancing downward motion and locking force, reducing reliance on complex mechanisms.

In the horizontal (flat) configuration, the arm lies within the plane of the circular track. It is extended outward from the hub until it engages the track with the desired pressure. Once aligned, it is locked in position. Adjustment may be made manually through a lever or mechanically through an actuator that shifts the arm outward and sets the correct tension electronically. Sensor feedback or manual input may guide this adjustment.

In both configurations, the arms maintain a consistent oblique angle during operation. There is no flexing or bending during motion—the arm's geometry is fixed. The locked angle, combined with the arm's contact with the track, allows a guided slipping interaction in which the arm rotates around the circular path due to its angled force projection. This slipping, constrained and repeatable, is enabled by friction-optimized materials or rolling contact features.

Spring-loaded and preset locking components ensure the arm stays rigidly angled and resists instability such as backlash. The constant geometry and applied pretension result in sustained tangential force and smooth rotational movement.

The circular track may feature shallow grooves, rails, or sidewalls to ensure the arm remains within a defined motion corridor. These features improve reliability and wear performance. In flat configurations, multiple arm-track assemblies can be positioned adjacently or stacked to increase torque output or electrical generation potential.

Together, the vertical and horizontal embodiments adapt the system for a wide variety of mechanical contexts. The vertical layout takes advantage of gravitational forces, while the horizontal version eliminates gravitational influence for consistent tension. Both allow precise control of tension using locking and actuator systems, enhancing the utility and predictability of the invention across applications.

Multiple arms may be positioned symmetrically around the hub. These arms may be synchronized either passively, through the system's mechanical balance and inertial dynamics, or actively through timed engagement mechanisms. The system design permits arrays of two, three, or more arms to work together in continuous cycles, enabling torque generation even under uneven or shifting load conditions. The rotating hub may be directly coupled to alternators or other motion conversion systems.

These figures collectively illustrate various modular embodiments of the invention, demonstrating the flexibility of the central concepts-namely, angular arm projection, controlled tension, and guided motion via grooves or magnetic repulsion. Each figure showcases the core operational mechanism in unique spatial orientations and mechanical formats designed to optimize torque output or frictionless propulsion depending on application context.

In a distinct but related embodiment, the invention employs a linear or curvilinear magnetic propulsion track with no central pivot or rotation axis. In this setup, a magnet is mounted at an angle on a moving platform, cart, or guided assembly. This platform rides along a track that contains magnets of similar polarity. The angle of the magnet decomposes the repelling force into two components: one orthogonal to the track (which helps with stability or levitation) and one tangential or parallel to the track's surface. The tangential force is what propels the platform forward.

The magnets may be permanent, electromagnetic, or a combination of both. The angle of mounting and the spacing of magnets along the track are optimized to maintain continuous propulsion along the desired path. This configuration allows for non-contact, frictionless motion ideal for cleanroom, vacuum, or high-wear environments. The absence of rotating parts reduces maintenance and extends operational longevity.

In magnetic configurations, the platform or arm is guided along a rail or embedded track groove. As the magnet approaches the repelling track segment, the angled force begins to push it forward. As the platform advances, it enters the next repelling zone, keeping the motion continuous. The linear motion system may also include switches or track geometries that enable direction reversal or looped circulation.

Both circular and linear systems may incorporate braking mechanisms. In the circular system, braking may occur at the central hub, at the arm-track interface, or through drag elements embedded in the arms. These brakes can be mechanical clamps, magnetic brakes, or resistive loads tied to energy harvesting systems. In the linear system, braking may occur through variable magnetic resistors, physical stoppers, or adjustable field strengths. These brakes can be used to slow down, regulate, or stop motion entirely based on operational needs.

In either embodiment, the system can be stopped, slowed, or locked using mechanical latches or rotational locks. Magnetic dampers may be applied to avoid sudden halts, and spring-based resistors can modulate force transitions. Sensors, including gyroscopes, encoders, or accelerometers, can be incorporated to monitor motion, detect misalignment, or prevent overspeed conditions. These sensors may be connected to alert systems or automatic safety locks.

The system is designed to work with various materials including wood, plastic, composites, and metals, depending on application requirements such as corrosion resistance, strength-to-weight ratio, or thermal characteristics. Components may be independently replaceable or modular in design, allowing users to scale systems up or down by altering the number of arms, track diameter, or magnetic segment count.

Output from the system may be harvested using direct mechanical linkages, rotary alternators, linear generators, or hydraulic couplers. The motion generated is consistent and reliable, whether through rotational torque or linear displacement, and can be easily integrated into broader energy systems.

In conclusion, the invention describes a mechanical motion generation platform capable of operating as either a central-rotation system with angled torque arms or a linear track system driven by decomposed magnetic repulsion. Both systems transform input force—either pressure, gravity, or magnetic tension—into usable mechanical energy suitable for a wide array of applications, including electric generation, motion transmission, or autonomous propulsion in vacuum, sealed, or difficult environments. This modular, low-maintenance design offers an energy-efficient and mechanically reliable alternative to traditional electric motors.

All mechanical systems that follow the core principles disclosed herein—such as angled force application, guided platform motion, torque generation through fixed-geometry resistance, vector decomposition of magnetic repulsion, or synchronized arm timing around a fixed hub—whether in rotational, linear, elliptical, or hybrid forms, are considered within the scope of this patent. Variants, adaptations, or future embodiments that leverage the described techniques to produce directional mechanical motion using comparable geometries or force arrangements are likewise included.

1. A mechanical rotational motion generation system comprising:
(a) a rotatable central hub positioned at the center of a continuous circular track;
(b) at least one arm connected to the hub, extending outward at a fixed tangential offset angle relative to the track;
(c) a contact interface between the arm and the track, comprising at least one of:
a low-friction rolling element, a sliding element, or a magnetic levitation element;
(d) a tensioning mechanism configured to maintain forceful engagement between the arm and the track, selected from mechanical locking systems, spring-based systems, gravity-based systems utilizing downward force in a vertical configuration, or outward-biased spring or actuator-based systems in a horizontal configuration;
(e) a coupling mechanism configured to transfer rotational energy from the hub to a mechanical load or an electrical generator.

2. The system of claim 1, wherein the circular track includes a groove or rail to guide the movement of the arm's contact interface.

3. The system of claim 1, wherein multiple arms are symmetrically or asymmetrically mounted around the hub to generate continuous rotational torque.

4. The system of claim 1, wherein the arm comprises telescoping segments or angularly adjustable joints to modify the tangential offset during operation.

5. The system of claim 1, wherein the system is enclosed within a housing suitable for operation in a vacuum, underwater, or corrosive environment.

6. The system of claim 1, further comprising a startup mechanism selected from manual cranks, pneumatic starters, or electromagnetic pulse initiators to commence rotational motion.

7. The system of claim 1, further comprising a braking system selected from mechanical locks, magnetic brakes, or adjustable resistive loads to regulate rotational speed.

8. A magnetic linear propulsion system comprising:
(a) a platform with at least one magnet mounted at a fixed angle relative to the platform base;
(b) a linear or curvilinear track comprising a repelling magnetic field aligned to interact with the magnet on the platform;
(c) a stabilization component selected from mechanical guides, magnetic levitation guides, or groove-based rails configured to maintain consistent propulsion alignment.

9. The system of claim 8, wherein the magnetic interaction is achieved using either two permanent magnets, a permanent magnet and an electromagnet, or two electromagnets.

10. The system of claim 8, wherein multiple platforms are arranged to travel along the track sequentially or in tandem to increase propulsion force or load capacity.

11. The system of claim 8, wherein the platform further comprises low-friction rollers or magnetic levitation features to reduce physical contact with the track.

12. The system of claim 8, further comprising a mechanical energy harvesting system coupled to the platform to convert linear motion into usable energy.

13. The system of claim 8, further comprising a braking system selected from adjustable magnetic fields, friction locks, or mechanical stoppers to regulate linear motion.

14. A method of generating mechanical motion comprising:
(a) providing a motion generation system comprising either:
(i) a rotatable hub with at least one arm extending tangentially to a continuous track; or
(ii) a platform with an angled magnet moving along a repelling magnetic track;
(b) applying tension or magnetic repulsion to create a tangential propulsion force, wherein tension is applied by weight-based gravitational force in vertical configurations or outward-biased spring or actuator mechanisms in horizontal configurations;
(c) moving the arm or platform along the track to produce continuous rotational or linear motion.

15. The method of claim 14, further comprising adjusting the arm angle or platform magnet angle during operation to optimize force output.

16. The method of claim 14, further comprising maintaining low-friction or non-contact guidance between the moving element and the track to reduce mechanical losses.

17. The method of claim 14, further comprising coupling the generated mechanical motion to an energy harvesting system selected from a generator, alternator, or mechanical load.

18. The method of claim 14, further comprising initiating motion using a startup system selected from a hand crank, pneumatic booster, or electromagnetic pulse.

19. The method of claim 14, further comprising regulating motion using braking elements selected from mechanical locks, magnetic brakes, or adjustable resistive elements.

20. The method of claim 14, wherein the system operates in environments including vacuum chambers, underwater installations, or corrosive industrial settings.
